(19) United States
(12) Patent Application Publication
(10) Pub. No.: US 2004/0202514 A1
(43) Pub. Date: Oct. 14, 2004

(54) Method of making mixutres such as concrete

(76) Inventors: Youichi Endo, Cresskill, NJ (US); Shozo Endo, Tokyo (JP); Shuji Endo, Tokyo (JP)

Correspondence Address: Cooper & Dunham LLP, 1185 Avenue of the Americas, New York, NY, 10036, US

(21) Appl. No.: 10/403,190

(22) Filed: Mar. 31, 2003

(51) Int. Cl. B65G 53/00

(52) U.S. Cl. 406/197

(57) ABSTRACT

The present invention provides a method of making quality, homogenous mixtures such as concrete without premixing the separate ingredients. In the example of concrete, the ingredients of cement, gravel, sand and water are metered and delivered to the use point separately using separate delivery means such as separate pneumatic hoses. The flow or delivery rate of each ingredient is measured and separately controlled, and the outputs of the individual delivery means meet at the common use point simultaneously where the concrete is to be laid down. The ratio of the ingredients may be adjusted to tailor the mix for particular applications. The ingredients meet and mix for the first time at the use point, and no premixing is performed.

### BACKGROUND OF THE INVENTION

The present invention is directed to a method of making mixtures, such as concrete, and will be described using concrete as an in the contest of example, but has application to any mixture.

Usually cement concrete consists of several different kinds of ingredients such as cement, sand, gravel and water, each of which ingredients have different specific gravity. Also, good quality concrete has to have all of these ingredients scattered and mixed homogeneously throughout the product. Thus, in order to make good concrete, the ingredients usually have to be mixed constantly using a concrete mixer before the concrete is laid own.

However mixing has its own set of attendant problems. For one, it is difficult to keep the homogeneity of concrete during the transport from a mixer to a site, for example when the site is high, far, or difficult to reach from the mixer and so on, because the ingredients separate and the mixture loses its homogeneity. Also, in order to get quality concrete products such as precise concrete in a factory, a good mixing of the concrete is necessary. However, it is difficult to keep the working area clean since the cement-water mixture splashes and sticks to surrounding objects. Additionally, if the mixture dries, it is difficult to scrape it off to clean the surrounding objects. These problems occur after the mixing ingredients, especially after water is combined.

Various methods as discussed in the following U.S. Patents, which are incorporated by reference herein, have been proposed for mixing ingredient of gravel, sand, cement and water for making concrete.

U.S. Pat. No. 5,597,120 to Chess, Jr. relates to use of dry and wet ingredients in separate hoppers which flow successively to fluidizing chamber 300 and then to a single nozzle.

U.S. Pat. No. 4,298,288 to Weisbrod relates to individual ingredient compartments with separate feed means delivering ingredients to a single mixing chamber 46.

U.S. Pat. No. 6,224,250 to Kreinheder et al. relates to separate tanks and pumps for individual ingredients going to a blender 50 for mixing.

U.S. Pat. No. 2,809,866 to Vessels relates to a homogenial mixer (see col. 2 lies 25 and following) for holding mixed cement and sand, which is combined with water at the point of use.

U.S. Pat. No. 4,792,234 to Doherty relates to a portable concrete batch plant having a mixer.

U.S. Pat. No. 4,390,371 to Cornwell relates to a static mixer 16 which receives ingredients and mixes them into cement product.

U.S. Pat. No. 3,881,656 to Markfelt et al. relates to a mixing apparatus for mixing dry material and water prior to dispersing.

U.S. Pat. No. 5,219222 to Babcock relates to a mixing column for mixing ingredients.

None of these references appears to show a mixing process or system which provides delivery of all of the ingredient separately and in controllable proportions/ratios directly to the use site without prior mixing.

### SUMMARY OF THE INVENTION

An object of the present invention is to avoid mixing, carrying, and pouring multi-ingredient mixtures such as concrete after the ingredients are put together and still achieve the homogeneity of the ingredients in the concrete.

The present invention provides a method of making quality and highly homogeneous product mixtures such as a mixing process. Homogeneity is a concept which describes how evenly ingredients are present in a given volume which is taken from the product. Thus, it is a relative concept, and it is related to the size of the testing volume. Generally speaking, the smaller the sample volume that is tested, the more difficult it is for one to achieve high homogeneity of the ingredients in the product.

Thus, conversely, if one makes a mixture of the ingredients in a small unit one can achieve a high homogeneity of the ingredients in a product.

Practically, to achieve the objectives of high homogeneity in a concrete product, for example, one can carry the ingredients such as cement, gravel, sand, and water separately using appropriate means such as separate pneumatic conveyer hose for each ingredient to the point where one lays down the concrete. Here, each ingredient is measured at the beginning of the hose and different ingredients reach at the ends of the respective hoses simultaneously so that the output end of the hoses the ratio of the amounts of the ingredients is always constant. Thus, the flows of the ingredients in the hoses can be continuous or discontinuous depending on the requirement of materials and the particular situation.

According to the present invention, process for providing a multi-ingredient mixture to a use site is provided, comprising delivering each of the ingredients separately, and in controllable proportions to the other ingredients, directly to the use site without prior mixing.

The present invention also provides a process for providing homogeneous concrete to a use site, comprising providing concrete ingredients separately, and in controllable proportions to other ingredients, directly to the use site without prior mixing.

### BRIEF DESCRIPTION OF THE DRAWINGS

FIG. 1 is a schematic representation of four ingredients for a mixture, according to the present invention; and

FIG. 2 is a diagram showing four ingredients of (1) stone or gravel, (2) sand, (3) cement and (4) water for making concrete.

### DETAILED DESCRIPTION OF THE PREFERRED EMBODIMENT

According to the present invention a process for providing a multi-ingredient mixture to a use site is provided, comprising delivering each of the ingredients separately, and in controllable proportions to the other ingredients, directly to the use site without prior mixing.

The multi-ingredient mixture may be concrete, wherein the ingredients include gravel, sand, cement and water.

The separate ingredients may be provided by separate feed hoses.

The separate ingredients may be provided in controllable proportions by controlling the pressure at which the respective ingredients are delivered.

The ingredients are provided in a continuous process or a discontinuous process.

The controllable proportions may be adjustable.

The present invention also provides a process for providing homogeneous concrete to a use site, comprising providing concrete ingredients separately, and in controllable proportions to other ingredients, directly to the use site without prior mixing.

The concrete ingredients may include gravel, sand, cement and water, and the controllable proportions may be adjustable.

The present invention provides a method of making quality, homogenous mixtures such as concrete without premixing the separate ingredients. In the example of concrete, the ingredients of cement, gravel, sand and water are metered and delivered to the use point separately using separate delivery means such as separate pneumatic hoses. The flow or delivery rate of each ingredient is measured and separately controlled, and the outputs of the individual delivery means meet at the common use point simultaneously where the concrete is to be laid down. The ratio of the ingredients may be adjusted to tailor the mix for particular applications. The ingredients meet and mix for the first time at the use point, and no premixing is performed.

The volume of mixture poured in a unit time can be considered as the product of the amount of ingredients poured in an infinitesimal time interval and the speed of the ingredients poured.

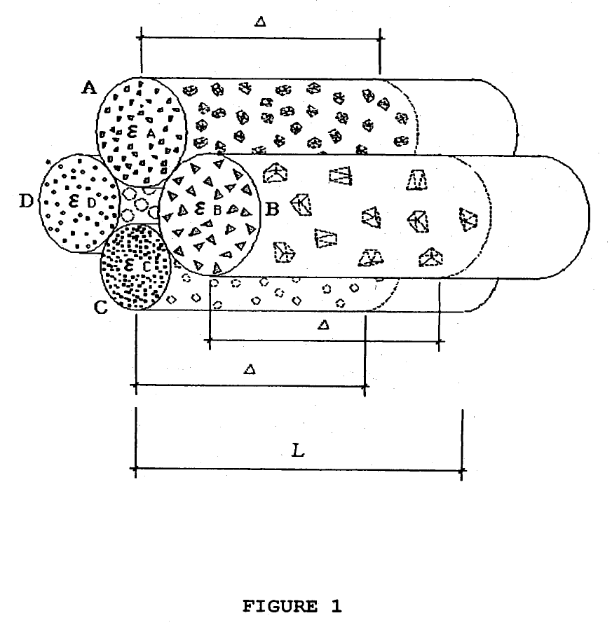

More precisely, with reference to FIG. 1, consider a case which has four ingredients A, B, C, and D, respectively.

The symbol εᵢ is the number of particles or areas of ingredients which appear in a section of a corresponding hose where i is one of A, B, C, and D.

The symbol Δ is the largest length of a unit chunk of ingredient A, B, C, and D measured and carried by the hoses.

The homogeneity of the ingredients in a product can be achieved by the constant ratio of the amount of ingredients in ε_{A}X Δ, ε_{B}X Δ, ε_{C}X Δ, ε_{D}X Δ. That is, as long as the ratio of four numbers ε_{A}X Δ, ε_{B}X Δ, ε_{C}X Δ, ε_{D}X Δ is kept constant in the pouring action, the homogeneity of the ingredients can be achieved even though one changes areas of sections of hoses and/or carrying speed of ingredients. Thus, pouring the ingredients A, B, C, and D in this manner has the same effect as making mixture of the ingredients in a small unit.

Also, the amount of concrete or mixture produced in a unit time can be enlarged by accelerating the carrying speed of the pneumatic conveyer and/or enlarging ε_{A}, ε_{B}, ε_{C} and ε_{D} without changing their ratio. In this way, the amount of each ingredient in a unit volume of the concrete sampled from any part of the product is constant so that the ratio of the ingredients is also constant without loosing the productivity.

Also, one can make quality concrete in any place as long as hoses can reach from the source of supply of the ingredients to the place where the concrete is to be laid. Thus, the objective of providing the mixed homogeneous concrete can be achieved without prior mixing of the ingredients.

Also, one can control the pouring action of concrete quite precisely with this method. One can apply this method not only to constructions of large structures with continuous pouring action but also to productions of small concrete products.

Although the most basic application of the inventive method is to pour several different ingredients simultaneously, one can also arrange the order of pouring materials if it is necessary, which cannot be done with the conventional method of making concrete by premixing the ingredients. One can apply this method not only to constructions of large structures with continuous pouring action but also to productions of small concrete products.

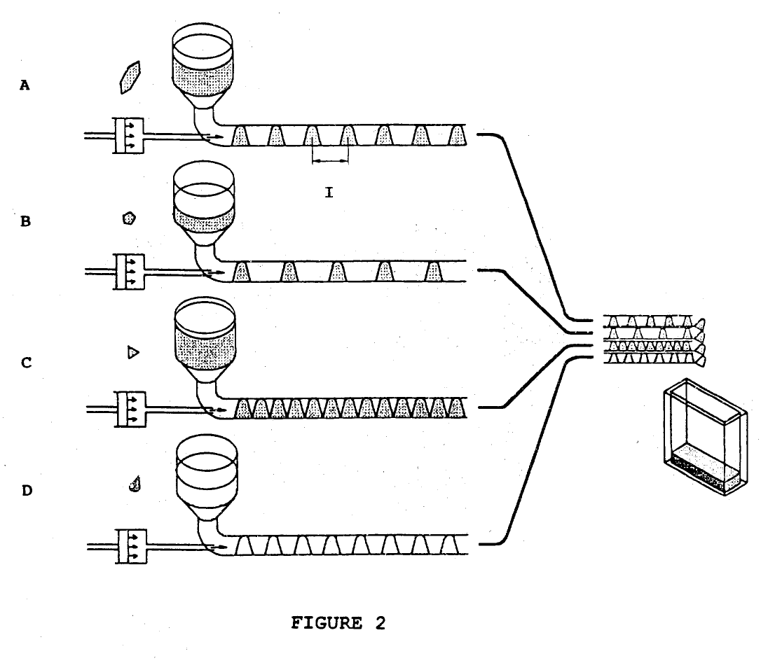

FIG. 2 shows ingredient A (gravel or stone), ingredient B (sand), ingredient C (cement) and ingredient D (water) being delivered through separate supply lines, and through controllable proportions or ratios, to a point of use site represented by the box at the extreme right. The separate ingredients are not mixed prior to their point of use. Because the ingredients are delivered to the point of use in controlled proportions and rates, no prior mixing is needed, and splashing on surrounding objects is avoided. The proportions and feed rates of each ingredient may be controlled by the feed rate of a conveyor mechanism or the like, the pressure exerted upon the material as illustrated by the boxes at the left in FIG. 2, the size of the conveyor mechanism or feed tube, or other means known to those skilled in the art. The interval I is determined by the ratio of ingredients and the speed of the conveyor.

Although the present invention has been described using concrete as an example, this method can also be applied to similar productions which require homogeneity of ingredients.

We claim:

1. A process for providing a multi-ingredient mixture to a use site, comprising delivering each of the ingredients separately, and in controllable proportions to the other ingredients, directly to the use site without prior mixing.

2. The process of claim 1, wherein the multi-ingredient mixture is concrete, and wherein the ingredients include gravel, sand, cement and water.

3. The process of claim 1, wherein the separate ingredients are provided by separate feed hoses.

4. The process of claim 1, wherein the separate ingredients are provided in controllable proportions by controlling the pressure at which the respective ingredients are delivered.

5. The process of claim 1, wherein the ingredients are provided in a continuous process.

6. The process of claim 1, wherein the ingredients are provided in a discontinuous process.

7. The process of claim 1, wherein the controllable proportions are adjustable.

8. A process for providing homogeneous concrete to a use site, comprising providing concrete ingredients separately, and in controllable proportions to other ingredients, directly to the use site without prior mixing.

9. The process of claim 8, wherein the ingredients include gravel, sand, cement and water.

10. The process of claim 8, wherein the controllable proportions are adjustable.
